(19) United States
(12) Patent Application Publication
(10) Pub. No.: US 2008/0246731 A1
(43) Pub. Date: Oct. 9, 2008

(54) Backside Control Utility, BCU.

(76) Inventor: Michael Chechelniker, Brooklyn, NY (US)

Correspondence Address: Michael Chechelniker, 3178 Nostrand ave. #5K, Brooklyn, NY, 11229, US

(21) Appl. No.: 11/697,736

(22) Filed: Apr. 8, 2007

(51) Int. Cl. G09G 5/00

(52) U.S. Cl. 345/168

(57) ABSTRACT

Backside Control Utility, BCU, is disclosed. Invention is an innovative way of BCU touchpad and keyboard in various applications as backside control utility, meaning locating touchpad and keyboard at a back of various hosting devices such as cellular phones, Tablet PCs, laptops, portable displays, portable music players and others. Invention can be embedded into a hosting device at manufacturing stage as BCU touchpad and keyboard components at the back of hosting device. BCU platform of BCU components, allows invention to be attached to any hosting device on the back. Invention comprises custom or universal attachment system, that allow BCU platform to be attached to the back of any device via universal attachment system, or to a specific device via custom attachment system. Invention is connected to a hosting device via wired and wireless connection. Navigating BCU responds to a regular cursor or text entry navigation. Invention, however, is used in single handed or dual handed navigation. Single handed navigation, mainly for BCU touchpad navigation, allows user to hold a mobile hosting device with a single hand and navigate BCU touchpad with a finger of the same hand. In dual handed navigation, user holds hosting device or BCU standalone platform with palms of both hands and navigates BCU keyboard or BCU touchpad with fingers other than thumbs. BCU emulation allows to emulate BCU on any touchscreen and use it in various applications. In one variation of invention, BCU dual display device is disclosed, comprising of at least one touchscreen with BCU emulation, and two displays at frond and back.

### FIELD OF THE INVENTION

Invention relates to portable devices incorporating touchpad and keyboard systems, and method of operation of such.

### BACKGROUND OF INVENTION

Touchpad has been a popular way to navigate notebook computer, and portable music playing devices as an onscreen cursor navigator, touch-wheel, or linear function utility. It has been historically used as a front navigation device by finger tips, as in laptop computers or by a thumb, as in portable music devices.

In such way, as front interacting utilities, almost everything is used today mainly touchscreen devices, touchpad and keyboard incorporating devices.

### SUMMARY OF INVENTION

Invention is an innovative way of BCU touchpad and keyboard in various applications as backside control utility, meaning locating touchpad and keyboard at a back of various devices such as cellular phones, Tablet PCs, laptops, portable displays, portable music players and others.

### BRIEF DESCRIPTION OF DRAWINGS

FIG. 1 represents BCU keyboard and touchpad in between.

FIG. 2 represents BCU keyboard being derived from a regular keyboard layout.

FIG. 3 represents embedded BCU touchpad of a cell phone variation of invention.

FIG. 4 represents single hand navigation of BCU touchpad.

FIG. 5 represents a display device with embedded BCU keyboard and touchpad.

FIG. 6 represents BCU platform.

FIG. 7 represents BCU platform with attached display device.

FIG. 8 represents BCU recombination capable platform.

FIG. 9 represents BCU keyboard halves and a hosting device.

FIG. 10 represents touchscreen emulated BCU.

### DETAILED DESCRIPTION OF INVENTION

Invention comprises of backside touchpad and keyboard and applications for which it is used as Backside Controlling Utility, BCU, for hosting devices. Hosting devices comprise variety of display devices such as cellular phones, PDAs, Tablet PCs, laptops, portable displays, portable music players and others. Invention allows these devices to have BCU keyboard and touchpad attached or embedded to their backside and navigated accordingly.

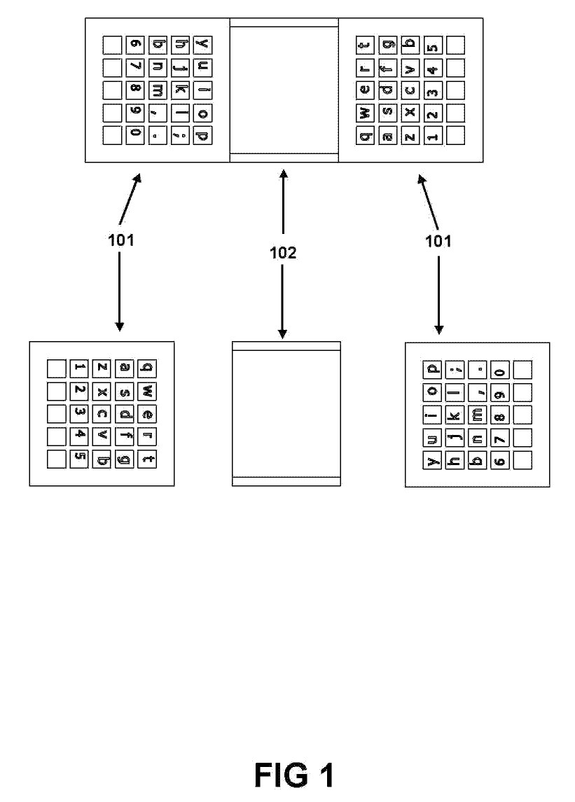

BCU keyboard and touchpad in between application of invention is shown in FIG. 1, comprising of keyboard halves (101) and touchpad (102). This allows invention at the reverse side or same said backside of a hosting devices to control keyboard and touchpad simultaneously.

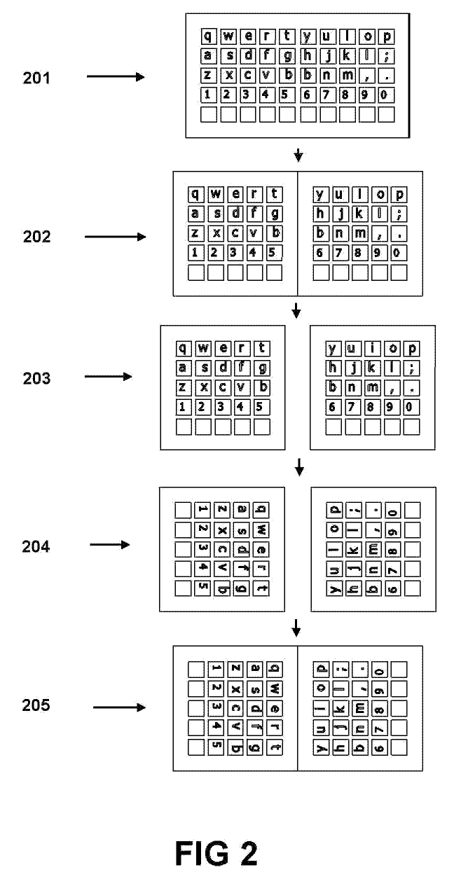

BCU keyboard, FIG. 2, is derived from standard keyboard layout (201) separated in the middle (202), wherein formed keyboard halves (203) of standard layout are further rotated 90 degrees to face each other (204) on the opposite sides of BCU keyboard (205).

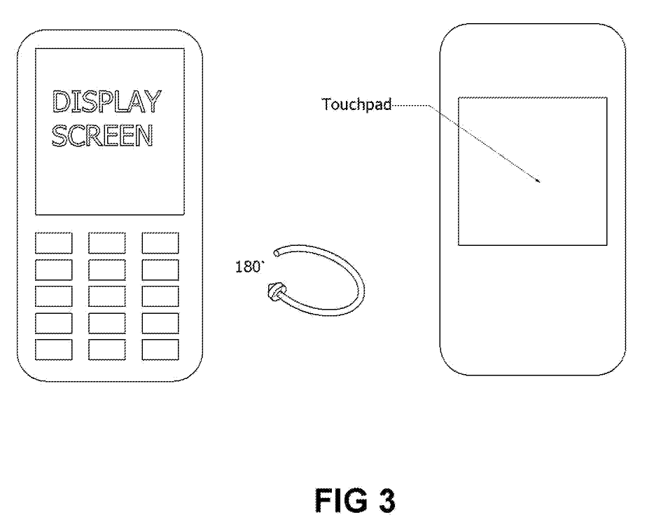

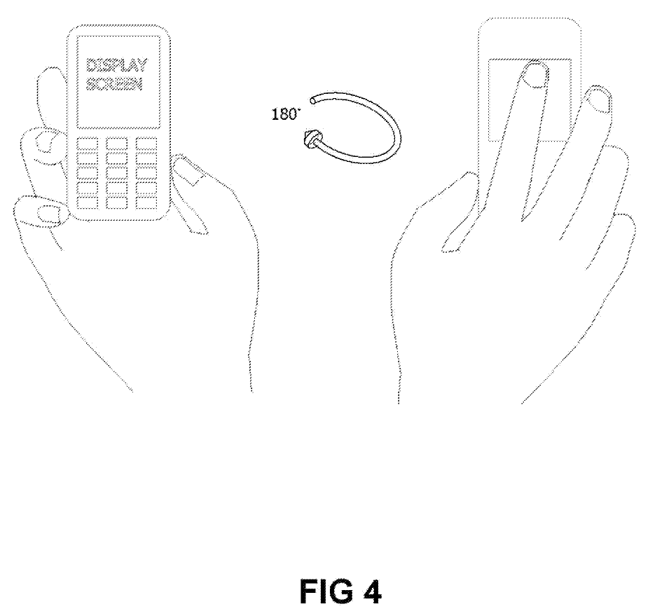

Invention is embedded or attached to hosting devices in various configurations that fit the need and the nature of hosting device. BCU touchpad only variation is used for cell phones that already have frontal keyboard or keypad, FIG. 3. In such case of single handed operation of BCU, user holds the hosting device such as cell phone, PDA or music player in a single hand, wherein a free finger of the holding hand is free to move about the back of the device's BCU touchpad zone, FIG. 4.

Limited function BCU touchpad is a single motion navigation that is often used in portable music devices as horizontal and vertical direction navigation, or circular direction touch wheel navigation. BCU touchpad can emulate both of these functions by using software interpretation of hardware navigation by finger. Linear function of touchpad can also be placed on the side of BCU platform or hosting device for thumb navigation of a single hand, while holding the device with said hands, and simultaneously navigating BCU touchpad.

Unlike regular touchpad devices, BCU touchpad uses horizontal mirror flip software interpretation in navigating BCU. If regular front touchpad device corresponds to onscreen cursor moving left when a finger is moved left, BCU touchpad corresponds in reverse. By moving finger left on a BCU touchpad if looked form the front at it, onscreen cursor moves to the right. By looking at hosting device, however, the effect is in sync with onscreen cursor. By moving finger left on BCU touchpad when looking at the hosting display device, onscreen cursor is moved left as well.

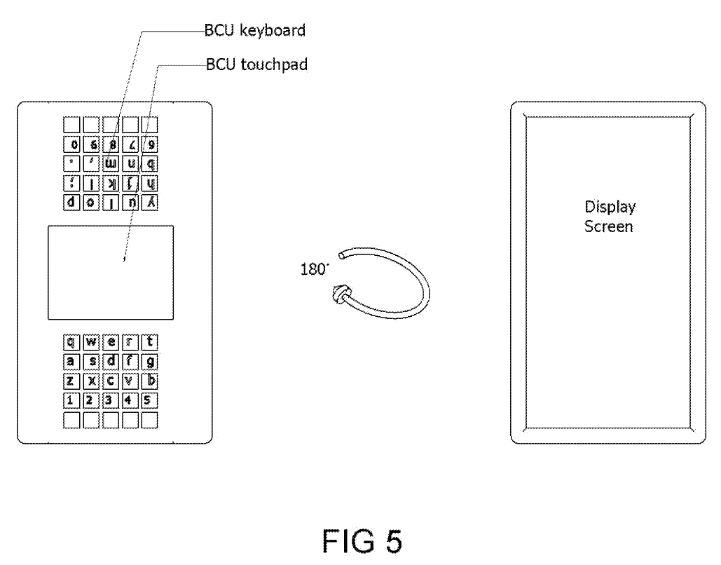

Hosting device embedded BCU is achieved at manufacturing or post manufacturing stage by embedding BCU components into the backside of hosting device. FIG. 5 shows a display device with embedded BCU.

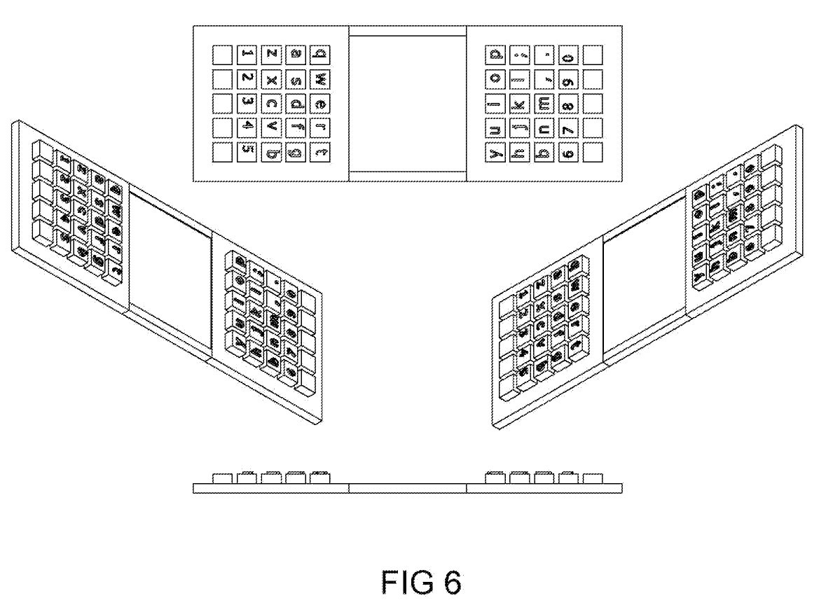

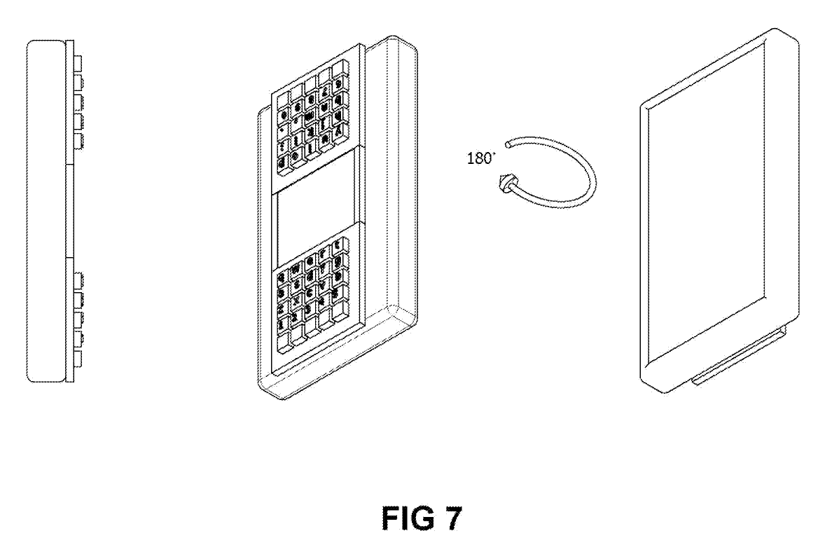

BCU platform is thin in one dimension and has a flat side on the other side of BCU, as shown in FIG. 6. Flat side allows invention to be attached to a hosting device and be locked in place by attachment system. Custom attachment system is manufactured to fit single or variety of devices, while universal attachment system allows for BCU to be attached to any device. Universal wired or wireless connection is used to connect BCU platform to a hosting device. In FIG. 7, BCU platform comprising of BCU keyboard and touchpad is attached to a display device and navigated by both hands. User holds hosting display device in portrait or vertical mode with palms of his hands and navigates BCU platform with his four fingers other than thumbs.

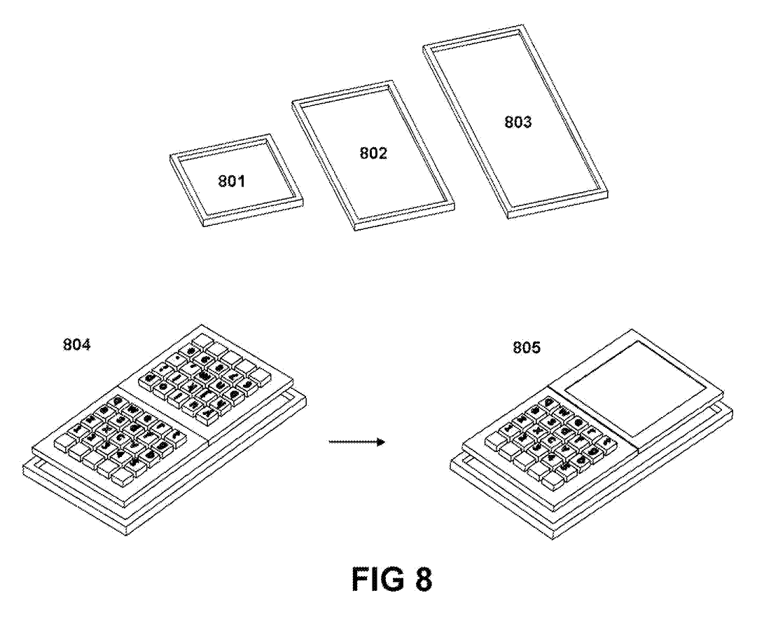

BCU recombination capable platform allows BCU platform components to be added to BCU platform base, FIG. 8. This allows for assembly of various BCU components other than keyboard and touchpad in a variety of combinations. Single (801), double (802) and triple (803) base allows for placing user desired components. In such instance, double base for example would allow user to place BCU keyboard (804), or remove it and place BCU touchpad on one side that is commonly used for gaming (805).

BCU platform is functional as a standalone device, meaning it is not physically attached to a hosting device, but connected via wired or wireless connection. This is useful to control hosting devices that are stationary such as TV's, laptops, eyewear displays, etc.

BCU of remote control allows for mouse cursor navigation of remote controlling devices when it is held in portrait mode by using BCU touchpad. This is useful for web browsing on TV. By flipping remote into landscape mode, user can use BCU keyboard as a text entry device.

Portable display web browsing is used in the same way. When user is holding a rectangular display device that has BCU in portrait mode, he is usually navigating and browsing pages with an onscreen cursor corresponding to BCU touchpad. When a text entry is needed, user can turn hosting display device into landscape mode and use BCU keyboard for text entry.

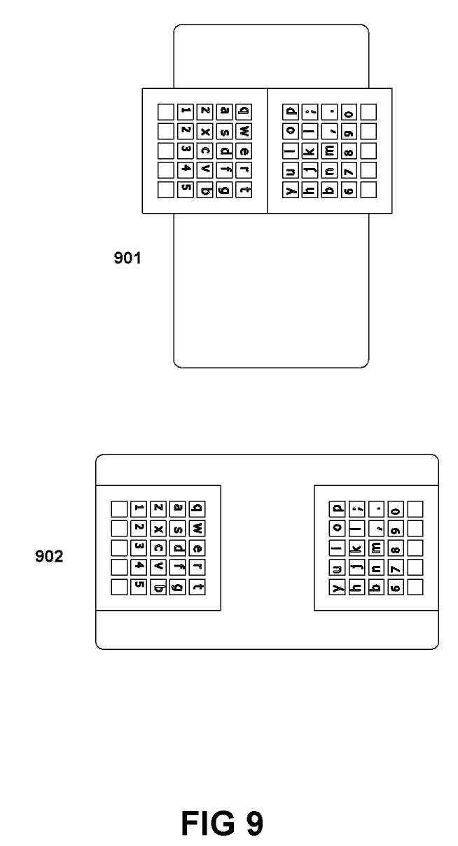

BCU keyboard can be connected to a hosting device as independent halves that are attached to the sides of hosting device, FIG. 9. This is done for universality of BCU platform in which case, BCU keyboard halves can be attached to virtually all devices currently requiring keyboard input. This version of universal device can fit a rectangular device positioned in portrait (901) or landscape (902) mode of a same device.

Virtual BCU comprises touchscreen display that serves as BCU by using emulating software that displays graphical components of BCU such as BCU keyboard halves. User presses the screen portions of BCU touchscreen emulation as if normal BCU, and it responds accordingly.

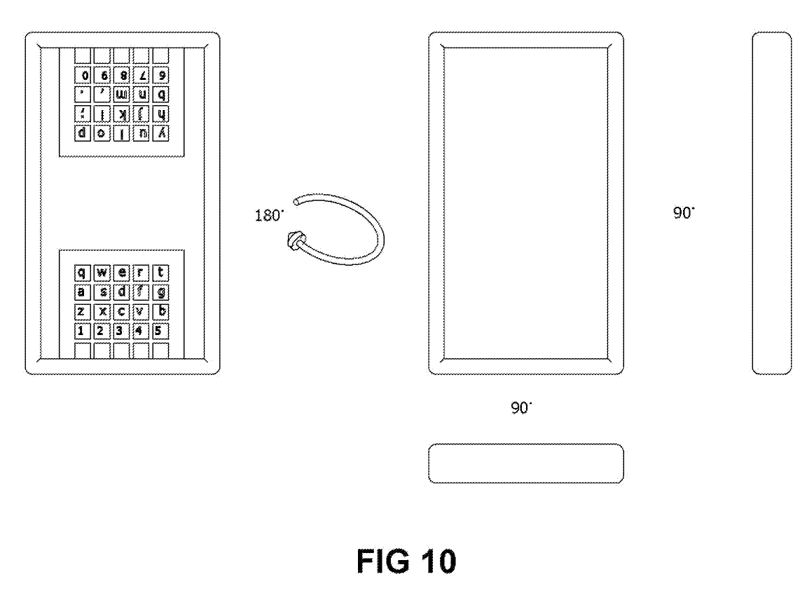

Double display device incorporating virtual BCU comprises of at least one touchscreen display that emulates BCU functions, FIG. 10. Such virtual BCU can be modified to user preferences with ease by a software that corresponds to user interaction with touchscreen and displays graphical representation of BCU accordingly. User can customize all aspects of BCU and its parameters. In another variation, BCU platform is a thin touchscreen display emulating BCU of above description.

BCU keyboard physically represented as embedded into hosting device or on BCU platform has blind help symbols for finger feel navigation and interaction with keyboard. This helps users to feel out the keys without the need of looking at the BCU keyboard. Standard keyboards and keypads have at least one finger feel identification mean such as a dot on number five in regular cell phone keypad that is felt by fingers. BCU keyboard, being completely out of sight behind the hosting device, use similar and even more extended finger feel key identification for feeling the intended keys rather than seeing them.

To better assist navigation of BCU, supporting belts are used. Such belts are attached to a hosting device or BCU platform. Supporting belts can go over hands or over thumbs for support in navigation of BCU.

What is claimed is:

1. Backside Control Utility, BCU, comprising:
BCU components being BCU keyboard halves and BCU touchpad;
BCU keyboard comprises of keyboard halves formed from separated in the middle standard keyboard layout that are rotated 90 degrees and facing each other on the opposite sides;
configurations of backside control utility including BCU touchpad only, BCU keyboard only, BCU keyboard with touchpad in the middle;
BCU touchscreen emulation that is a touchscreen with software keyboard and touchpad graphically represented;
BCU variations comprises BCU components arranged in variations of space, parameters, and shapes.

2. BCU of claim 1, wherein BCU is placed on the back of hosting device.

3. BCU of claim 1, wherein BCU keyboard comprises halves of standard keyboard key layout that are separated in the middle to form halves.

4. BCU of claim 1, wherein keyboard halves are rotated 90 degrees to each other so that horizontally allied rows of keys of a standard keyboard layout are vertically parallel to each other.

5. BCU of claim 1, wherein BCU touch-screen emulation is a visual representation of BCU on touchscreen display, that responds to proper simulated function.

6. BCU of claim 1, wherein BCU components comprises BCU keyboard halves, BCU touchpad, BCU gamepad that are placed on the back of hosting device.

7. BCU of claim 1, wherein BCU keyboard with touchpad is BCU keyboard and a touchpad in between the BCU keyboard halves.

8. BCU of claim 1, wherein BCU touchpad only configuration is BCU touchpad component on the back of hosting device.

9. BCU of claim 1, wherein BCU keyboard only configuration is BCU keyboard halves on a back of hosting device.

10. BCU of claim 1, wherein BCU configurations is variation of combination of BCU keyboard, BCU touchpad, BCU gamepad, and other buttons on a single BCU assembly or in combination with BCU and hosting device assembly.

11. Backside Control Utility, BCU, comprising:
BCU platform;
BCU platform that is attached to a hosting device or used as a standalone device;
BCU connected to a hosting device via signal connection;
BCU platform physical attachment system that allows BCU platform to be attached to a hosting device in a single assembly;
BCU embedded into hosting device at manufacturing stage;
BCU platform touchscreen emulation;
BCU keyboard halves separates;
BCU recombination capable platform with at least one slot for assembling and reassembling of same sized BCU recombination capable platform components.

12. BCU of claim 11, wherein BCU platform comprises a flat side.

13. BCU of claim 11, wherein BCU platform comprises BCU variations on reverse side.

14. BCU of claim 11, wherein BCU platform is thin enough on other sides.

15. BCU of claim 11, wherein BCU platform comprises signal connection system to a hosting device.

16. BCU of claim 11, wherein signal connection system is universal electronic connection between hosting device and BCU that corresponds to pressing keys, navigating touchpad, and navigating touchscreen of BCU.

17. BCU of claim 11, wherein signal connection system comprises wireless connection between hosting device and BCU.

18. BCU of claim 11, wherein signal connection system comprises wired connection between hosting device and BCU.

19. BCU of claim 11, wherein BCU platform comprises physical attachment system to a hosting device.

20. BCU of claim 11, wherein physical attachment system is a housing body that attaches hosting device and a BCU platform.

21. BCU of claim 11, wherein physical attachment system comprises custom attachment variation that is made for specific hosting device.

22. BCU of claim 11, wherein physical attachment system comprises universal housing attachment to fit most devices.

23. BCU of claim 11, wherein BCU is embedded into hosting device on reverse side of main side of hosting device.

24. BCU of claim 11, wherein hosting device is any display device such as display screen, PDA, laptop, Tablet PC, gamepad, cell phone, remote control and such.

25. BCU of claim 11, wherein BCU platform is connected to a hosting device.

26. BCU of claim 11, wherein BCU keyboard halves separates is BCU keyboard halves that are separately attached to a hosting device.

27. BCU of claim 11, wherein BCU recombination capable platform is BCU platform capable of reassembly of its BCU components with at least one slot for placing such components.

28. BCU of claim 11, wherein BCU recombination capable platform components are BCU components that are physical in nature and similar in size to fit BCU recombination capable platform.

29. BCU of claim 11, wherein BCU platform emulation is BCU touchscreen emulation of BCU platform with touchscreen display on the back side of BCU platform.

30. Backside Control Utility, BCU, comprising:
BCU that is navigated by using four fingers other than thumbs;
BCU that is navigated by using a single finger other than thumb on BCU touchpad while holding a hosting device with a single hand;
hand supporting belts for navigation of BCU;
thumb supporting belts for navigation of BCU;
BCU of game controller;
BCU of remote control;
BCU of cell phone;
dual display device incorporating emulated BCU;
thumb navigation of BCU hosting device;
BCU keyboard with finger assistant.

31. BCU of claim 30, wherein BCU is navigated by using four fingers other than thumbs.

32. BCU of claim 30, wherein BCU is navigated by using a single finger other than thumb on BCU touchpad while holding a hosing device with a single hand.

33. BCU of claim 30, wherein hand supporting belts for navigation of BCU is a belt over hand that is attached to BCU platform or BCU embedded device for support in navigation of BCU.

34. BCU of claim 30, wherein thumb supporting belts for navigation of BCU is a belt over thumb that is attached to BCU platform or BCU embedded device for support in navigation of BCU.

35. BCU of claim 30, wherein BCU of game controller is a game controller and attached or embedded BCU on the back to be used for text entry and other gaming control.

36. BCU of claim 30, wherein BCU of remote control is a remote control and attached or embedded BCU on the back to be used for text entry and other remote controlling.

37. BCU of claim 30, wherein BCU of cell phone is a cell phone and attached or embedded BCU on the back to be used for single finger navigation of BCU touchpad, text entry of BCU keyboard and other cell phone function navigation.

38. BCU of claim 30, wherein dual display device incorporating emulated BCU is a flat device with display screens on the back and front and at least one touchscreen to be emulated by software to correspond to BCU by functional and visual means in all BCU form varieties.

39. BCU of claim 30, wherein thumb navigation of BCU hosting device is navigation of BCU hosting device using thumbs of the same hand that is used in BCU navigation.

40. BCU of claim 30, wherein BCU keyboard with finger assistant is a BCU keyboard that incorporates blind help feel symbols or other identification mean for fingers of a hand to feel the keyboard keys rather than see.
